(19) United States
(12) Patent Application Publication
(10) Pub. No.: US 2014/0298274 A1
(43) Pub. Date: Oct. 2, 2014

(54) METHOD AND ELECTRONIC DEVICE FOR PROCESSING DATA

(71) Applicants: NTT Docomo, Inc., Tokyo (JP); Samsung Electronics Co., Ltd., Gyeonggi-do (KR)

(72) Inventors: Hyun-Young Yang, Seoul (KR); Mitsuhiro Goto, Tokyo (JP); Mitsuru Nagasaka, Tokyo (JP); Takayuki Maino, Tokyo (JP); Ji-Hyun Kang, Seoul (KR); Kwang-Lae Kwak, Seoul (KR); Su-Bin Park, Gyeonggi-do (KR)

(73) Assignees: NTT Docomo, Inc., Tokyo (JP); Samsung Electronics Co., Ltd., Gyeonggi-do (KR)

(21) Appl. No.: 14/222,214

(22) Filed: Mar. 21, 2014

(30) Foreign Application Priority Data
Mar. 22, 2013 (KR) 10-2013-0031001
Mar. 11, 2014 (KR) 10-2014-0028442

(51) Int. Cl. G06F 3/0488

(52) U.S. Cl. CPC G06F 3/0488
USPC 715/863

(57) ABSTRACT

An electronic device and method for not exposing a memo to the others when delivering a corresponding memo in the electronic device to a specific user are disclosed. An electronic device for processing data includes at least one processor, a memory, and at least one program stored in the memory and executed by the at least one processor, wherein the program causes the at least one processor to receive data from a user, detect a user's gesture, and transform a form of the data based on the detected user's gesture. A method in an electronic device includes receiving a memo from a user, framing a memo with a memo frame, detecting a user's gesture and transforming a form of the memo frame based on the detected user's gesture.

### PRIORITY

This application claims priority under 35 U.S.C. §119 to an application No. 10-2013-0031001 filed in the Korean Intellectual Property Office on Mar. 22, 2013 and an application No. 10-2014-0028442 filed in the Korean Intellectual Property Office on Mar. 11, 2014, the contents of which are incorporated herein by reference.

### TECHNICAL FIELD

Various embodiments of the present disclosure relate generally to a method and an electronic device for storing data.

### BACKGROUND

With the rapid development of electronic devices recently, electronic devices capable of providing wireless voice calls and information exchange become the necessities of life. At the initial spread of the electronic devices, although they has been recognized that it is possible to simply carry and make wireless calls, as technology is developed and wireless internet is introduced, since their application range has been wider (for example, games, remote controller using short range communication, and image capturing by a mounted digital camera as well as the purpose of a simple phone call or scheduling), the needs of users have been satisfied.

The amount of information to be processed or displayed by the electronic device in order for multimedia services are provided is increased. Accordingly, an electronic device including a touch screen, which is capable of increasing the size of a display unit by improving the utilization of space, receives attention increasingly.

The touch screen is an input or display device for inputting or displaying information on one screen. Accordingly, when the touch screen is used, the electronic device may increase a display area by removing an additional input device such as a keypad. For example, if an entire screen uses a full touch method using the touch screen, the screen size may be is expanded by using the front of the electronic device as a screen.

Furthermore, an electronic device equipped with the touch screen may support a memo function for writing a text or a number or drawing a figure on a displayed content by using an input means such as a stylus pen and an electronic pen.

In general, such a memo function may store a written memo or share it with other users.

### SUMMARY

To address the above-discussed deficiencies, it is a primary object to provide a memo stored in the electronic device may be delivered to a specific user and such a memo may be exposed to others.

For example, if an electronic device is exposed without setting an additional lock function, a memo stored in the electronic device is exposed together.

Furthermore, if a memo not set with an additional lock function is transmitted to another electronic device, it is stored in the other electronic device and thus, as mentioned above, is likely to be exposed to other.

According to an aspect of the present disclosure, An electronic device for processing data include: at least one processor, a memory, and at least one program stored in the memory and executed by the at least one processor, wherein the program causes the at least one processor to receive data from a user, detect a user's gesture, and transform a form of the data based on the detected user's gesture.

According to another aspect of the present disclosure, a method in an electronic device includes receiving a memo from a user, framing a memo with a memo frame, detecting a user's gesture and transforming a form of the memo frame based on the detected user's gesture.

According to another aspect of the present disclosure, a computer readable storage medium storing a program for use with a processing circuitry, the program causing the processing circuitry to receive data from a user, frame the data with a memo frame, detect a user's gesture; and transform a form of the memo frame according to the a user's gesture.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of a data storage device;

FIG. 2 is a flowchart illustrating a data storing operation of an electronic device according to an embodiment of the present disclosure;

FIG. 3 is a flowchart illustrating an operation of generating secret data in an electronic device according to an embodiment of the present disclosure;

FIG. 4 is a flowchart illustrating an operation of generating secret data in an electronic device according to another embodiment of the present disclosure;

FIGS. 5A to 5C are views illustrating a screen of generating secret data in an electronic device according to an embodiment of the present disclosure;

FIGS. 6A to 6D are flowcharts illustrating an operation of generating secret data in a preset mode of an electronic device according to an embodiment of the present disclosure;

FIGS. 7A to 7C are flowcharts illustrating an operation of generating secret data in a user define mode of an electronic device according to an embodiment of the present disclosure;

FIGS. 8A to 8D are views of transforming the form of a memo frame in an electronic device according to an embodiment of the present

FIG. 8E is a view illustrating an operation of displaying an image of the rear of a memo frame by transforming the memo frame in an electronic device according to an embodiment of the present disclosure;

FIG. 8F is a flow chart illustrating an operation of displaying an image of the rear of a memo frame by transforming the memo frame in an electronic device according to an embodiment of the present disclosure FIG. 9A is a flowchart illustrating an operation of playing secret data in an electronic device according to an embodiment of the present disclosure;

FIG. 9B is a view illustrating an opening determination function when a memo frame is restored in an electronic device according to an embodiment of the present disclosure.

FIGS. 10A to 10D illustrate an operation of generating secret data in an electronic device according to an embodiment of the present disclosure;

FIG. 11A is a view illustrating an operation of generating secret data in an electronic device according to an embodiment of the present disclosure

FIG. 11B is a view illustrating a process of generating secret data in an electronic device according to an embodiment of the present disclosure; FIG. 12A is a view illustrating an operation of providing a guideline for secret data in an electronic device according to an embodiment of the present disclosure; and

FIG. 12B is a view illustrating an operation of providing a guideline for secret data in an electronic device according to an embodiment of the present disclosure

### DETAILED DESCRIPTION

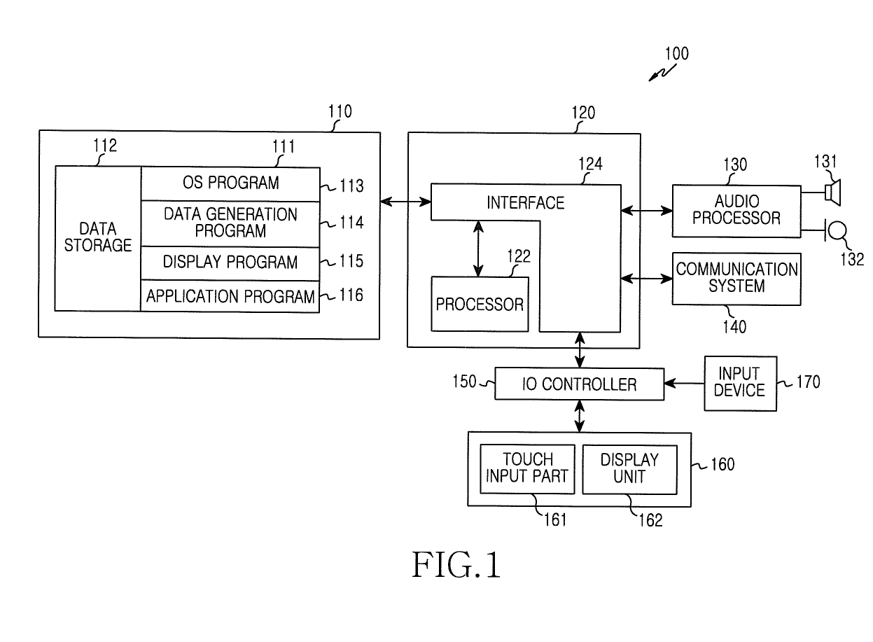

FIGS. 1 through 12B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, embodiments of the present disclosure will be described in more detail with reference to the accompanying drawings. In the following description, detailed descriptions of related well-known functions or configurations will be omitted if they would obscure the disclosure with unnecessary detail. Also, the terms used herein are defined according to the functions of the present disclosure. Thus, the terms may vary depending on user's or operator's intentions or practices. Therefore, the terms used herein must be understood based on the descriptions made herein.

A data storing method and device for improving security in an electronic device according to various embodiments of the present disclosure are described below. The electronic device may improve data security by transforming and transmitting a form of data of a written memo. Furthermore, the electronic device may restore a form according to a procedure by tagging a transformation procedure.

Here, the memo can include text data such as Hangul, alphabet, numbers, Japanese, Chinese, formulas, symbols and graphic data such as shapes, notes, and graphs, which are inputted through a gesture occurring on a touch screen by an input means such as a user's finger and an electronic pen and a key input of a keypad.

Furthermore, the electronic device can be a portable electronic device, and also can be a device such as a portable terminal, a mobile phone, a media player, a tablet computer, a handheld computer, or a Personal Digital Assistant (PDA). Additionally, the electronic device can be an arbitrary portable electronic device combining at least two functions among such devices.

The present disclosure relates to a technology for improving security on data content in an electronic device.

FIG. 1 is a block diagram illustrating a configuration of a data storage device.

As shown in FIG. 1, the electronic device 100 can include a memory 110, a processor unit 120, an audio processing unit 130, a communication system 140, an input/output control unit 150, a touch screen 160, and an input device 170. Here, one of the processor 110 and the memory 140 can be provided in plurality.

Each component will be described as follows.

The memory 110 can include a program storage unit 111 storing a program for controlling an operation of the electronic device 100 and a data storage unit 112 storing data generated during program execution. For example, the data storage unit 112 can store updatable various data for storage such as phone books, outgoing messages and incoming messages, and also can store a transformation procedure of data transformed by the electronic device. Furthermore, the data storage unit 112 can store information on a transformable format as secret data or a format transformed into secret data.

Additionally, the program storage unit 111 can include an operating system (OS) program 113, a data generation program 114, a display program 115, and at least one application program 116. Here, a program included in the program storage unit 111 can be expressed in an instruction set as a set of instructions.

The OS program 113 can include various software components controlling general system operations. The control of such general system operations means memory management or control, storage hardware (device) control or management, or power control or management, for example. The OS program 113 can serve to allow smooth communication between hardware (devices) and program components (modules).

The data generation program 114 can include various software components for inputting a memo by detecting a user's gesture.

At this point, the data generation program 114 can input a memo by executing a memo input available application such as a memo application, a document application, an image edit application, a text message writing application, and an e-mail writing application.

The data generation program 114 can generate data of a written memo as secret data by detecting a user's gesture.

Here, the secret data can be data for transforming the form of a memo frame where a written memo is displayed in order not to expose a memo inputted by a user's gesture to others.

Furthermore, the data generation program 114 may confirm the transformation point and transformation information of a memo frame by detecting a user's gesture.

Moreover, the data generation program 114 can confirm a transformation procedure for a memo frame and can tag it to secret data.

In addition, the data generation program 114 can restore the transformed memo frame by detecting a user's gesture corresponding to the transformation procedure.

The display program 115 can include various software components for providing and displaying graphics on the touch screen 160. The term “graphics” can include texts, webpages, icons, digital images, videos, and animations.

Furthermore, the display program 115 can include various software components relating to a user interface.

The display program 115 can display an operation of generating a memo frame where a written memo is displayed as secret data.

Furthermore, the display program 115 can display a secret data playback operation of restoring secret data into a memo frame.

Furthermore, the display program 115 can display a guideline for a transformation or restoration situation in a current state during a secret data generation or playback operation.

The application program 116 can include a software component for at least one application program installed on the electronic device 100 and can include a program for generating the secret data and storing the generated secret data. This is that a function for transforming the form of a written memo frame and generating data as secret data is provided as one application.

The processor unit 120 can include at least one processor 122 or interface 124. Here, the processor 122 or the interface 124 can be integrated as at least one integrated circuit or can be implemented using an additional component.

The interface 124 can serve as a memory interface controlling access to the processor 122 and the memory 110.

Furthermore, the interface 124 can serve as a peripheral device interface controlling connection between an input/output peripheral device and the processor 122 of the electronic device 100.

The processor 122 can control the electronic device 100 through at least one software program so that the electronic device 100 can generate data as secret data by transforming a memo frame where a written memo outputted and can restore the memo frame by transforming the form of the secret data. At this point, the processor 122 can control to perform a function corresponding to a corresponding program by executing at least one program stored in the memory 110. For example, the processor 122 can include a graphic processor for performing processing relating to the generation and playback of secret data. Such a graphic processor can generates secret data by transforming the form of a memo frame where a written memo is displayed and can restore the memo frame by restoring the secret data to display the written memo.

That is, the secret data generation and playback function of the electronic device 100 can be performed by using software such as a program stored in the memory 110 or hardware such as the processor.

The audio processing unit 130 can provide an audio interface between a user and the electronic device 100 through a speaker 131 or a microphone 132.

The communication system 140 can perform a communication function for voice communication or data communication of the electronic device 100. At this point, the communication system 140 can include a plurality of communication sub modules supporting different communication networks. For example, a communication network is not limited to the above, and can include Global System for Mobile Communication (GSM) network, Enhanced Data GSM Environment (EDGE) network, Code Division Multiple Access (CDMA) network, W-Code Division Multiple Access (W-CDMA) network, Long Term Evolution (LTE) network, Orthogonal Frequency Division Multiple Access (OFDMA) network, wireless LAN, Bluetooth network, or Near Field Communication (NFC) and can exchange secret data where the form of a memo frame is transformed with another electronic device. Furthermore, the communication system 140 can transmit/receive information on a transformation procedure of secret data.

The input/output control unit 150 can provide an interface between an input/output device such as a touch screen 160 or an input device 170 and an interface.

The touch screen 160, as an input/output device for outputting/inputting information, can include a touch input unit 161 and a display unit 162.

The touch input unit 161 can provide touch information detected through a touch panel to the processor unit 120 through the input/output control unit 150. At this point, the touch input unit 161 can change touch information into an instruction structure such as touch_down, touch_move, and touch_up and can provide it to the processor unit 120, and also can generate a gesture for secret data generation for a memo frame where the written memo is displayed and a gesture for the restoration of secret data.

The display unit 162 can display state information of the electronic device 100, characters entered by a user, moving pictures, or still pictures. For example, the display unit 162 can display an operation of generating secret data for a memo frame where the written memo is displayed and an operation of restoring and playing the secret data. Furthermore, the display unit 162 can display a guideline for a memo frame transformable in a current state and a guideline for secret data restorable in a current state.

The input unit 170 can provide input data generated by a user's selection to the processor unit 120 through the input/output control unit 150. For example, the input device 170 can be configured including only a control button for controlling the electronic device 100. As another example, the input device 170 can be configured using a keypad for receiving input data from a user, and can generate secret data for a memo frame where the written memo is displayed or generate input data for restoring the secret data.

Although not shown, the electronic device 100 can further include components for providing additional functions such as a broadcast receiving module for receiving a broadcast, a digital music playback module such as an MP3 module, a short-range wireless communication module for short-range wireless communication, and a proximity sensor module for proximity sensing and also, further include software for operations thereof.

According to various embodiments of the present disclosure, an electronic device for string data can include at least one processor, a memory, and at least one program stored in the memory and configured to be executed by the at least one processor. The program can include an instruction for transforming the format of data by detecting a user's gesture.

According to various embodiments, the program can tag a transformation procedure by the gesture to the transformed data and can store and process the data tagged with the transformation procedure.

According to various embodiments, the program can display a transformable form of list.

According to various embodiments, the program can confirm a transformation point of data according to the detected gesture and can transform the data on the basis of the confirmed transformation point.

According to various embodiments, the program can confirm a transformation method of data according to the detected gesture and can transform the data through the confirmed transformation method.

According to various embodiments, the program can transmit the data tagged with the transformation procedure.

According to various embodiments, on the receipt of the data tagged with the transformation procedure, the program can restore the transformed data by detecting a gesture corresponding to the transformation procedure.

According to various embodiments, the program can store an opening determination gesture of a transmitter in data tagged with a transformation order of the data form.

According to various embodiments, a receiver of the data tagged with the transformation procedure can reproduce the opening determination gesture and when the stored opening determination gesture is identical to the reproduced opening determination gesture, can restore the transformed data. The restoration of the transformed data can detect a gesture corresponding to the transformation order and can restore the transformed data.

According to various embodiments, the opening determination gesture can be handwriting, voice or a touch operation.

According to various embodiments, if a gesture corresponding to the transformation procedure is not detected, the program can perform an authentication operation so as to determine whether to access data.

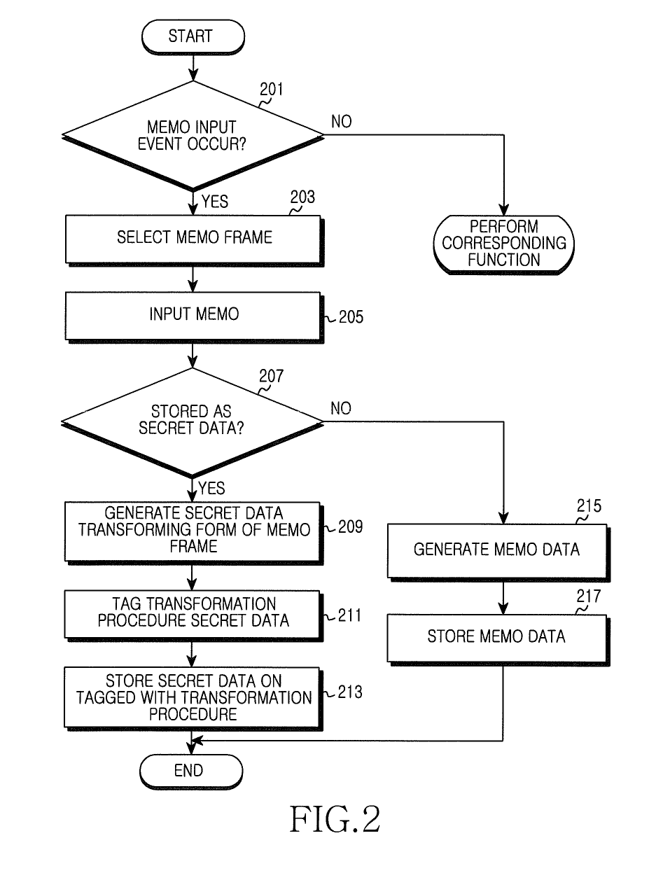

FIG. 2 is a flowchart illustrating a data storing operation of an electronic device according to an embodiment of the present disclosure.

Referring to FIG. 2, the electronic device can support a function for inputting a memo or an indicator of inserting a memo frame (a memo frame selection for inputting a memo) through a gesture occurring on a touch screen by an input means such as a user's finger and an electronic pen and a key input of a keypad. Here, the memo can include text data such as Hangul, alphabet, numbers, Japanese, Chinese, formulas, and symbols and graphic data such as shapes, notes, and graphs.

Additionally, the above-mentioned gesture can mean that a touch pattern is made on a touch screen of an electronic device. A touch can be executed on a touch screen of an electronic device through an input means such as a user's finger or an electronic pen. The gesture can include at least one of an input (touch) touching the touch screen through a user's finger or an input means, an input (tap) tapping the touch screen through the input means, an input (drag) dragging a predetermined pattern while a touch on the touch screen is maintained, and an input (drag and drop) where a touch is dragged or released while being maintained. Of course, the gesture can include an input occurring on a touch screen, for example, swipe, pinch, and flick, besides the above-mentioned inputs.

The electronic device can perform different operations on the basis of whether a memo input event occurs in operation 201. Here, the memo input event can be a situation inputting the above-described memo and also can be a situation executing a memo input available application such as a memo application, a document application, an image edit application, a text message writing application, and an e-mail writing application.

In more detail, when a memo input event does not occur, the electronic device can perform a function corresponding to a state thereof. Herein, the performing of the corresponding function can be an operation of executing a multimedia player or entering a standby mode according to a user's input.

In addition, the electronic device can select a memo frame for inputting a memo by detecting a user's gesture in operation 203. Here, the memo frame can be a form in which a memo corresponding to a gesture is displayed.

In addition, the electronic device can input a memo by detecting a user's gesture in operation 205. At this point, the electronic device can input a memo corresponding to a gesture to a memo frame.

Of course, the electronic device can select the memo frame before detecting a user's gesture for memo input but can select the memo frame after the memo frame is completed.

Furthermore, the electronic device can detect a user's input for storing the written memo as secret data in operation 207.

Here, the secret data can be data for transforming the form of a memo frame in order not to expose a memo inputted by a user's gesture to others.

In general, when a memo is stored, the electronic device can store it while maintaining the form of a memo frame where an inputted memo is displayed. In this case, the memo displayed in the memo frame can be easily exposed to others.

In order to solve these problems, the electronic device can transform the form of a memo frame where an inputted memo is displayed, according to a direction and a width that a user wants. The transforming of the memo frame is to transform a formal form of memo frame, for example, origami, to create a specific form.

Furthermore, the transforming of the memo frame is to crumple a formal form of memo frame through an undefined method.

In general, the memo frame can be compared as a piece of paper for inputting a memo and the memo can be displayed on the other side. The transforming of the memo frame means that one side where the memo is displayed can overlap a portion of the other side. Thus, an entire or portion of the displayed memo may not be confirmed completely due to the deformation of the memo frame.

For example, if it is assumed that a memo is disposed on the front side of a rectangular memo frame and the front sides overlap each other on the basis of the center of the memo frame, the memo displayed on the front side may not be confirmed.

On the contrary, if the back sides overlap each other on the basis of the center of the memo frame, the front side form of the memo frame is reduced in half, so that a portion of the displayed memo may not be confirmed.

Furthermore, the electronic device can generate memo data when the written memo is not stored as secret data in operation 215. Here, the memo data are data including a memo inputted by a user's gesture. The memo data, as data generated from a memo writing available application, can include document data such as .PDF format data and .doc format data.

Furthermore, the electronic device can generate memo data and store in a data storage area in operation 217.

In addition, the electronic device can generate the written memo as secret data in operation 209. At this point, the electronic device can generate the secret data by transforming the form of the memo frame. In such a case, the electronic device can support a preset mode for generating a predetermined form of secret data and a user define mode for generating secret data in a form corresponding to a user's gesture.

The preset mode can define a form of at least one secret data and can define a transformation procedure for generating each form of secret data in advance.

Accordingly, when the form of secret data is selected by a user, the electronic device operating in the preset mode can confirm the transformation procedure of the selected secret data and can transform the form of a memo frame where a memo inputted according to the confirmed transformation procedure is displayed can transform the form of the memo frame.

The user define mode can define a transformation method of a memo frame corresponding to a gesture form of a user. Furthermore, the user define mode can confirm a transformation point for a memo frame by detecting a user's gesture. Here, a user's gesture form can be an input direction of a gesture. For example, the electronic device can transform the memo frame in a first direction on the basis of a gesture detected point with respect to a gesture moving from the top to the bottom.

As another example, the electronic device can transform the memo frame in a second direction on the basis of a gesture detected point with respect to a gesture moving from the bottom to the top. Here, the transforming of the memo frame in the first direction is to transform the front sides of the memo frame to overlap each other and the transforming of the memo frame in the second direction is to transform the back sides of the memo frame to overlap each other.

Moreover, the electronic device can tag the transformation procedure (sequence) for the memo frame on the generated secret data in operation 211. Here, tagging the transformation procedure is to add a transformation order of the memo frame on the secret data. This is because the transformation order of a memo frame can be used as decryption information on the secret data. That is, when the memo frame is restored in the reverse order of the transformation order, the electronic device receiving the secret data can display a memo displayed in the memo frame on a display unit.

Moreover, the electronic device can store secret data with a tagged transformation procedure for a memo frame in operation 213.

Moreover, the electronic device can deliver the generated secret data to a user of another electronic device through transmission service including text message, e-mail, multimedia message, and instant message.

Furthermore, the electronic device can register the generated secret data through social network service.

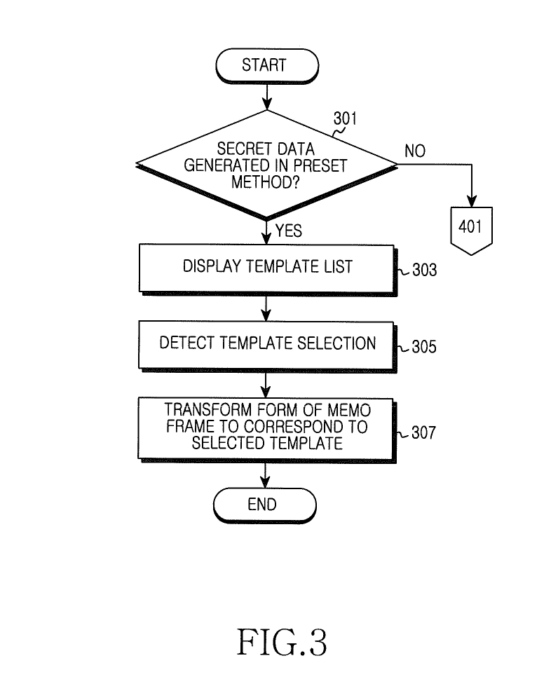

FIG. 3 is a flowchart illustrating an operation of generating secret data in an electronic device according to an embodiment of the present disclosure.

Referring to FIG. 3, the electronic device can generate secret data for a memo frame by using a preset mode for generating a predetermined form of secret data.

In order for the preset mode, the electronic device can define the form of at least one secret data and can pre-define a transformation procedure for generating each form of secret data in advance. The form of the secret data can be added or deleted by a user.

The electronic device can confirm a secret data generating method in operation 301. That is, the electronic device can support a user define mode for transforming secret data to correspond to a user's gesture.

Furthermore, when secret data are generated using a preset mode, the electronic device can display a template list in operation 303. Here, the template list can be a list for forms of secret data generated using the preset mode. Accordingly, a user of the electronic device can generate a desired form of secret data by selecting the form of secret data included in the list.

Furthermore, the electronic device can add a user defined form to the template list or can receive a template that a server providing a template or another user uses to add the received template to the template list.

Furthermore, the electronic device can detect an input for selecting a form of template to be generated after displaying the template list in operation 305.

In addition, the electronic device can transform the form of a memo frame to correspond to the form of the selected template in operation 307.

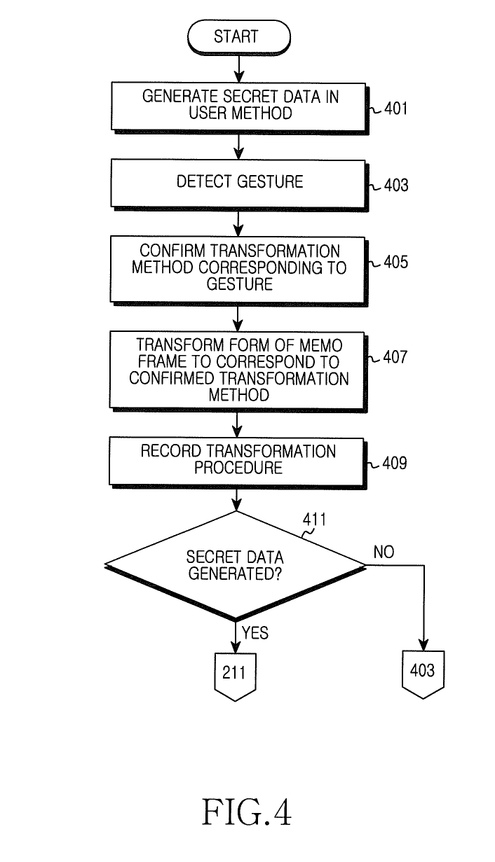

FIG. 4 is a flowchart illustrating an operation of generating secret data in an electronic device according to another embodiment of the present disclosure.

Referring to FIG. 4, the electronic device can generate secret data for a memo frame by using a user define mode for transforming data to correspond to a user's gesture in operation 401.

At this point, the electronic device can transform the form of a memo frame by using a user's gesture form.

Furthermore, the electronic device can confirm a transformation point for a memo frame by detecting a user's gesture. That is, when detecting a gesture touching a screen as if a line was drawn on a portion of the memo frame, the electronic device can transform the form of the memo frame on the basis of the gesture detected point.

For example, when detecting a gesture (that is, a gesture moving from the top to bottom direction) corresponding to the first direction, the electronic device can transform the memo frame in the first direction on the basis of the transformation point.

As another example, when detecting a gesture (that is, a gesture moving from the bottom to top direction) corresponding to the second direction, the electronic device can transform the memo frame in the second direction on the basis of the transformation point.

Here, the transforming of the memo frame in the first direction is to transform the front sides of the memo frame to overlap each other and the transforming of the memo frame in the second direction is to transform the back sides of the memo frame to overlap each other.

The electronic device for operating in the user define mode can detect a gesture in operation 403. Here, the electronic device can detect a gesture for determining the transformation point of the memo frame and the transformation form of the memo frame.

In addition, the electronic device can confirm the transformation method corresponding to the detected gesture in operation 405.

At this point, the electronic device can confirm the transformation method of the memo frame by using a gesture occurrence direction. For example, when detecting a gesture (that is, a gesture moving from the top to bottom direction) corresponding to the first direction, it is confirmed that the electronic device can need to transform the memo frame in the first direction on the basis of the transformation point.

As another example, when detecting a gesture (that is, a gesture moving from the bottom to top direction) corresponding to the second direction, it is confirmed that the electronic device can need to transform the memo frame in the second direction on the basis of the transformation point.

Here, the transforming of the memo frame in the first direction is to transform the front sides of the memo frame to overlap each other and the transforming of the memo frame in the second direction is to transform the back sides of the memo frame to overlap each other.

In addition, the electronic device can transform the form of a memo frame to correspond to a method corresponding to the detected gesture in operation 407.

In addition, the electronic device can record a transformation procedure for the memo frame in operation 409. At this point, the electronic device can use the transformation procedure as decryption information on the secret data by recording the transformation order of the memo frame. That is, when the secret data of the transformed memo frame are restored in the reverse order, the electronic device can decrypt the secret data.

Moreover, the electronic device can confirm whether secret data of the transformed memo frame are generated while transforming the form of the memo frame in operation 411.

Furthermore, the electronic device can transform the form of the memo frame before the secret data are generated.

Moreover, when the form of the memo frame is transformed and secret data are generated, the electronic device can tag a transformation procedure of the memo frame on the secret data and store it.

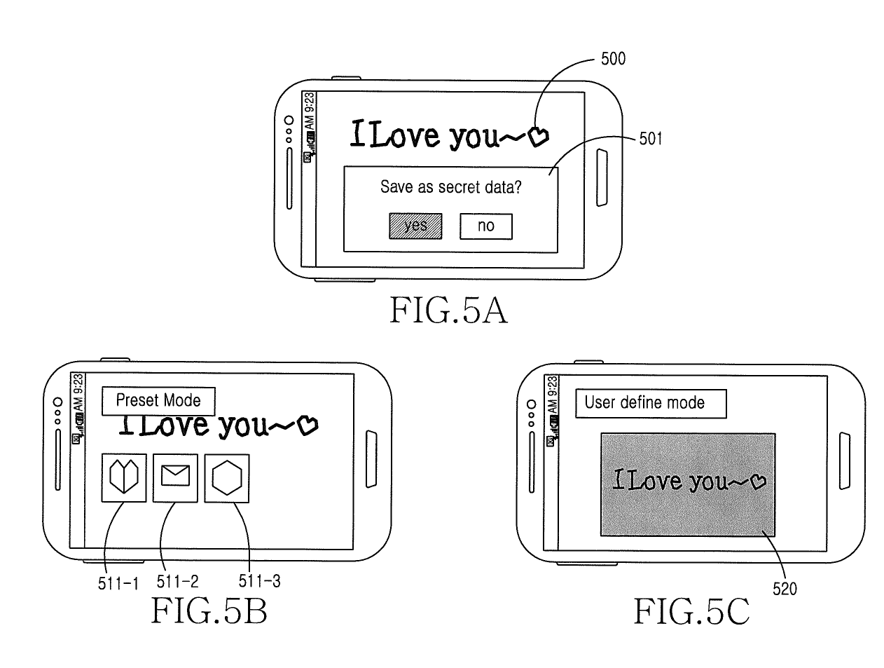

FIG. 5 is a view illustrating a screen of generating secret data in an electronic device according to an embodiment of the present disclosure.

Referring to FIG. 5, the electronic device can provide a function for writing a memo including text data such as alphabet, numbers, Hangul, Japanese, Chinese, formulas, symbols and graphic data such as shapes, notes, and graphs, which are inputted through a gesture occurring on a touch screen by using an input means such as a user's finger and an electronic pen and a key input of a keypad.

Furthermore, the electronic device can execute a memo input available application to allow the memo writing, for example, a memo application, a document application, an image edit application, a text message writing application, and an e-mail writing application.

Moreover, the electronic device can store a written memo as document data such as .PDF format data and .doc format data.

In addition, the electronic device can store the written memo as secret data. Here, the secret data can be data for transforming the form of a memo frame in order not to expose a memo inputted by a user's gesture to others.

That is, as shown in FIG. 5A, when detecting a gesture for storing the written memo 500, the electronic device can display a menu 501 for confirming whether to store data as secret data. FIG. 5A illustrates a view that an input for storing a written memo “I Love You˜ [symbol] ” as secret data occurs.

One of the reasons for transforming the form of the memo frame is that a memo displayed in a memo frame is easily exposed to others.

In order to solve these problems, the electronic device can transform the form of a memo frame where an inputted memo is displayed, according to a direction and a width that a user wants. The transforming of the memo frame is to transform a formal form of memo frame, for example, origami, to create a specific form.

While a written memo is stored, the electronic device can support a preset mode for generating a predetermined form of secret data and a user define mode for generating secret data in a form corresponding to a user's gesture.

The preset mode can define a form of at least one secret data and can define a transformation procedure for generating each form of secret data in advance.

Accordingly, when the form of secret data is selected by a user, the electronic device operating in the secret mode can confirm the transformation procedure of the selected secret data and can transform the form of a memo frame where a memo inputted according to the confirmed transformation procedure is displayed can transform the form of the memo frame.

That is, as shown in FIG. 5B, the electronic device for operating in the preset mode can display a template list representing a form to which the memo frame of a written memo is transformable. Here, the template list can be a list for forms of secret data generated using the preset mode.

As shown in FIG. 5B, the electronic device can display a template list for transforming the written memo “I Love You˜ [symbol] ” into a heart form 511-1, an envelope form 511-2, and a hexagonal form 511-3.

Accordingly, a user of the electronic device can generate a desired form of secret data by selecting the form of secret data included in the list.

Furthermore, the electronic device can add a user defined form to the template list or can receive a template that a server providing a template or another user uses to add the received template to the template list.

Furthermore, as shown in FIG. 5C, the electronic device for operating in the user define mode can display the memo frame 520 where a written memo is displayed.

That is, the electronic device can display a memo frame for detecting a gesture for determining the transformation point of the memo frame and the transformation form of the memo frame.

In addition, the electronic device can confirm a transformation method corresponding to the detected gesture and can transform the form of the displayed memo frame to correspond to the confirmed transformation method.

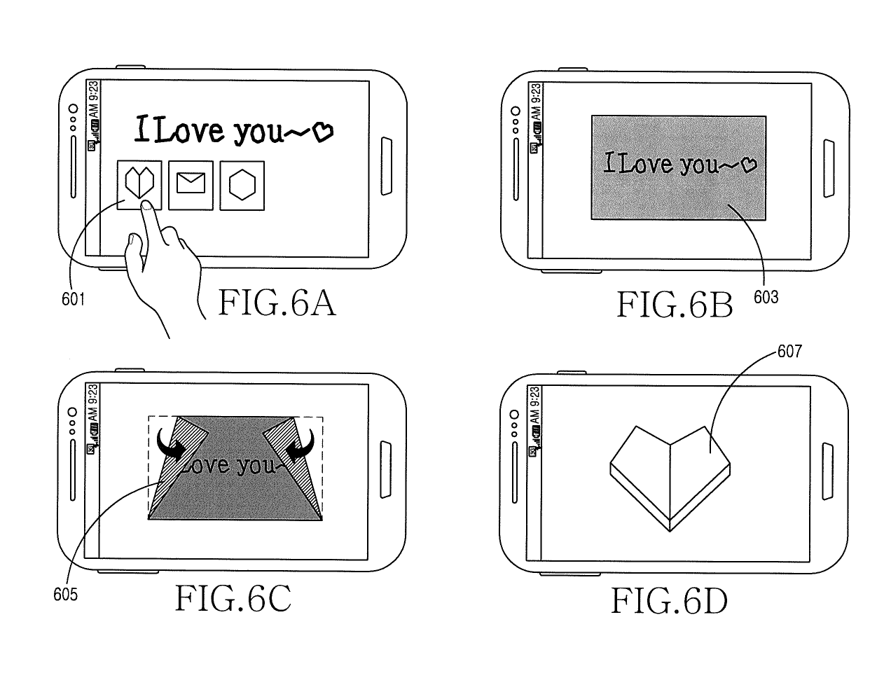

FIG. 6 is a flowchart illustrating an operation of generating secret data in a preset mode of an electronic device according to an embodiment of the present disclosure.

Referring to FIG. 6, the electronic device can provide a function for writing a memo including text data such as alphabet, numbers, Hangul, Japanese, Chinese, formulas, symbols and graphic data such as shapes, notes, and graphs, which are inputted through a gesture occurring on a touch screen by using an input means such as a user's finger and an electronic pen and a key input of a keypad.

In addition, the electronic device can store the written memo as secret data. Here, the secret data can be data for transforming the form of a memo frame in order not to expose a memo inputted by a user's gesture to others.

The electronic device can generate secret data of a transformed memo frame in order to prevent a memo written by a user from being exposed to others.

The electronic device can support a preset mode to generate a predetermined form of secret data while a written memo is stored. That is, when generating secret data by using a preset mode, the electronic device can display a template list, that is, a list of the forms of secret data generated in the preset mode, as shown in FIG. 6A.

As shown in FIG. 6B, the electronic device can display a template list for transforming the written memo “I Love You˜ [symbol] ” into a heart form, an envelope form, and a hexagonal form.

Furthermore, the electronic device can add a user defined form to the template list or can receive a template that a server providing a template or another user uses to add the received template to the template list.

Accordingly, a user of the electronic device can generate a desired form of secret data by selecting the form of secret data included in the displayed template list.

As shown in the drawing, when a user detects an input 601 for selecting a heart form of secret data, the electronic device can transform 605 a rectangular form of a memo frame 603 shown in FIG. 6B into a heart form of a memo frame shown in FIG. 6C.

The form of the memo frame shown in FIG. 6C can be a form transformed through one of transformation operations for forming a heart form. The electronic device can store an operation of transforming a form into a heart form in advance and thus can display a transformation operation according to a stored order.

Accordingly, a user can recognize an operation of generating a heart form of secret data according to a displayed order.

When the operation of transforming the memo frame is completed, the electronic device can display 607 the memo frame where a memo is written and displayed, as secret data shown in FIG. 6D. Although the memo frame is displayed and a portion of the written memo is exposed as shown in FIG. 6A to 6C, the memo is not exposed in the transformed secret data as shown in FIG. 6D.

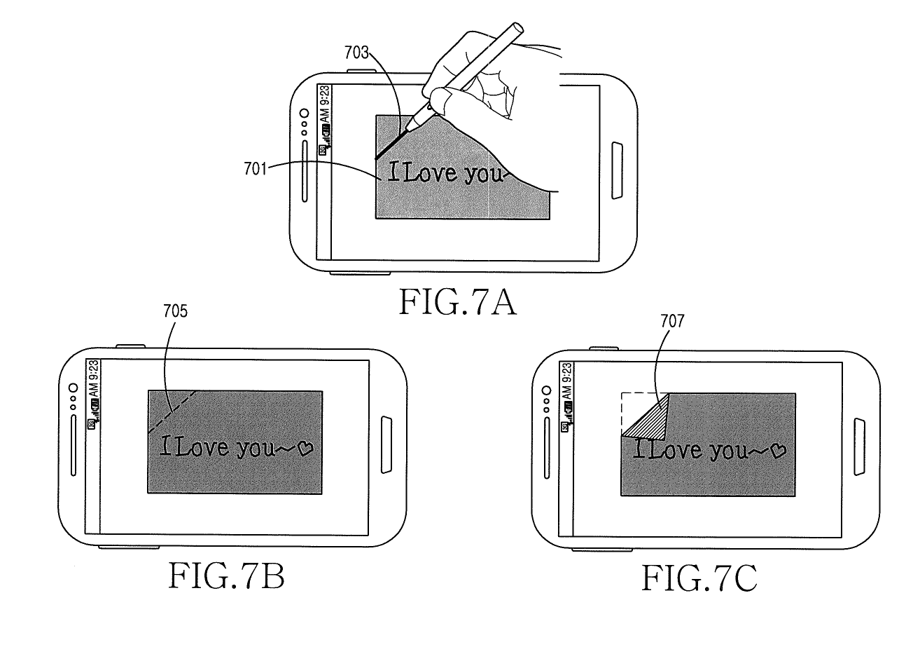

FIG. 7 is a flowchart illustrating an operation of generating secret data in a user define mode of an electronic device according to an embodiment of the present disclosure.

Referring to FIG. 7, the electronic device can provide a function for writing a memo including text data such as alphabet, numbers, Hangul, Japanese, Chinese, formulas, symbols and graphic data such as shapes, notes, and graphs, which are inputted through a gesture occurring on a touch screen by using an input means such as a user's finger and an electronic pen and a key input of a keypad.

In addition, the electronic device can store the written memo as secret data. Here, the secret data can be data for transforming the form of a memo frame in order not to expose a memo inputted by a user's gesture to others.

The electronic device can generate secret data of a transformed memo frame in order to prevent a memo written by a user from being exposed to others.

The electronic device can support a user define mode to generate a form of secret data corresponding to a user's gesture while a written memo is stored. That is, when generating secret data by using a user define mode, the electronic device can detect a user's gesture 701 on a memo frame 700 as shown in FIG. 7A.

FIG. 7A illustrates a view that a gesture for changing a memo frame through an electric pen occurs at the left top of a memo frame including a written memo “I Love You˜ [symbol] ”. Furthermore, as shown in FIG. 7A, a user inputs a gesture for moving from the bottom of the left diagonal to the top of the left diagonal through an electronic pen. Additionally, a corresponding gesture is not limited to the electronic pen and for example, a corresponding gesture can be represented by an operation of swiping from the left bottom to the right top through finger touching. Additionally, a corresponding gesture can be executed according to a method such as voice recognition and text input.

The electronic device detecting the gesture can confirm a transformation point 705 for a memo frame as shown in FIG. 7B. In the drawing, a position indicated with a dotted line can be a transformation point.

Furthermore, the electronic device can confirm a transformation point for a memo frame and a transformation method of a memo frame by detecting a user's gesture. At this point, the electronic device can confirm the transformation method of the memo frame by using a gesture input direction. For example, the electronic device can transform a memo frame in a first direction on the basis of a gesture detected point with respect to a gesture moving from the top to the bottom.

Furthermore, the electronic device can transform 707 the memo frame on the basis of the transformation point through the confirmed method by detecting the gesture as shown in FIG. 7C.

FIG. 7C illustrates a view that the memo frame is transformed in the first direction on the basis of the transformation point of the memo frame. Here, the transforming of the memo frame in the first direction is to perform transformation to allow the front sides of the memo frame to overlap each other on the basis of the transformation point. The transformed memo frame may not expose a portion of the memo as shown in FIG. 7C.

A user of the electronic device can transform the form of the memo frame by repeating a gesture generating operation. Furthermore, as an operation of transforming the form of the memo frame is repeated, a memo area can be reduced.

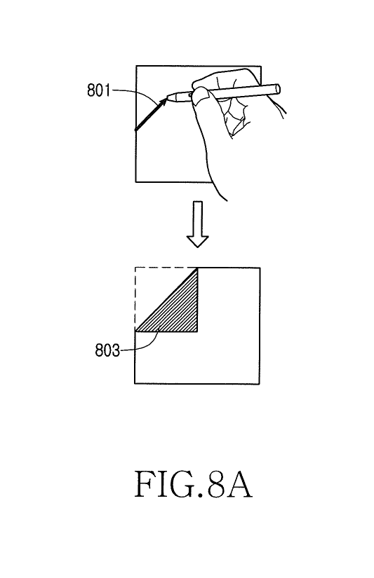

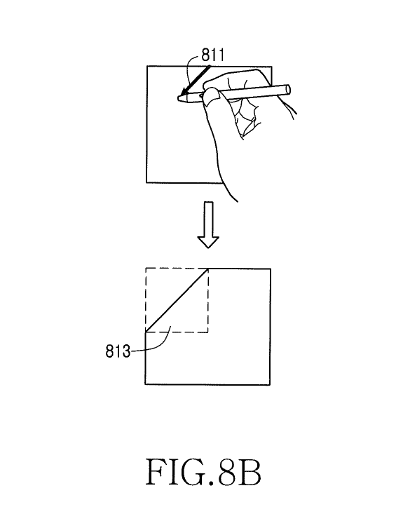

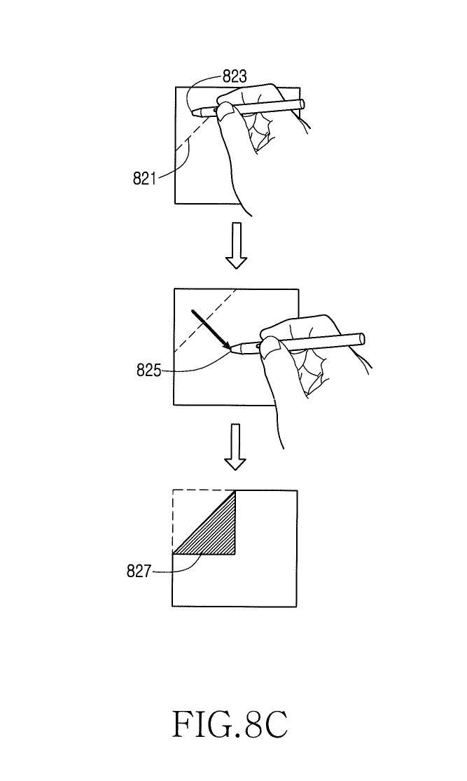

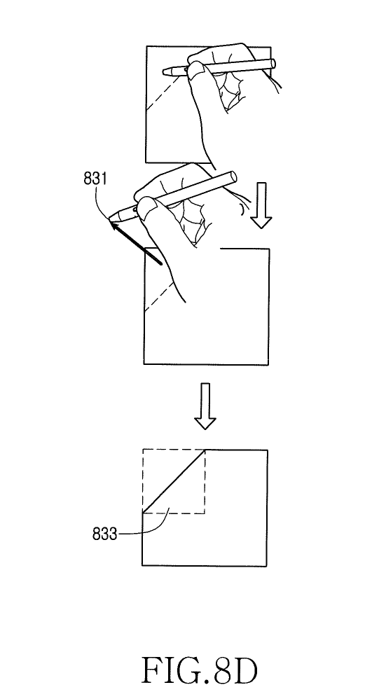

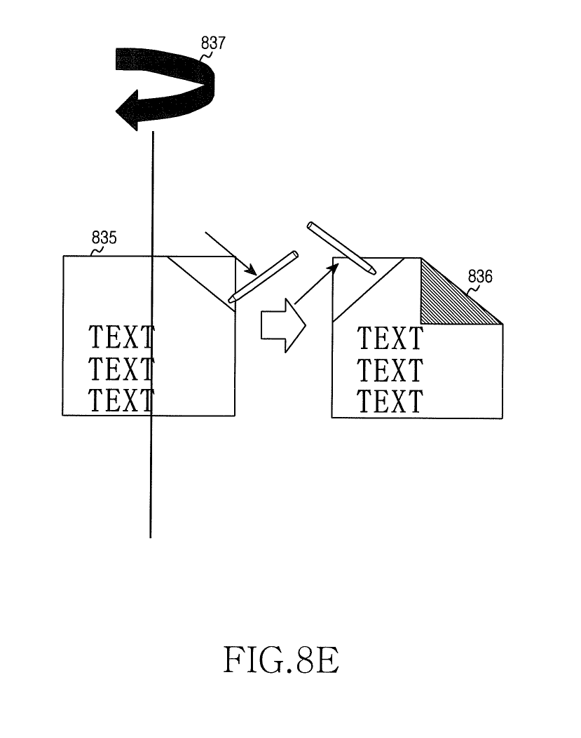

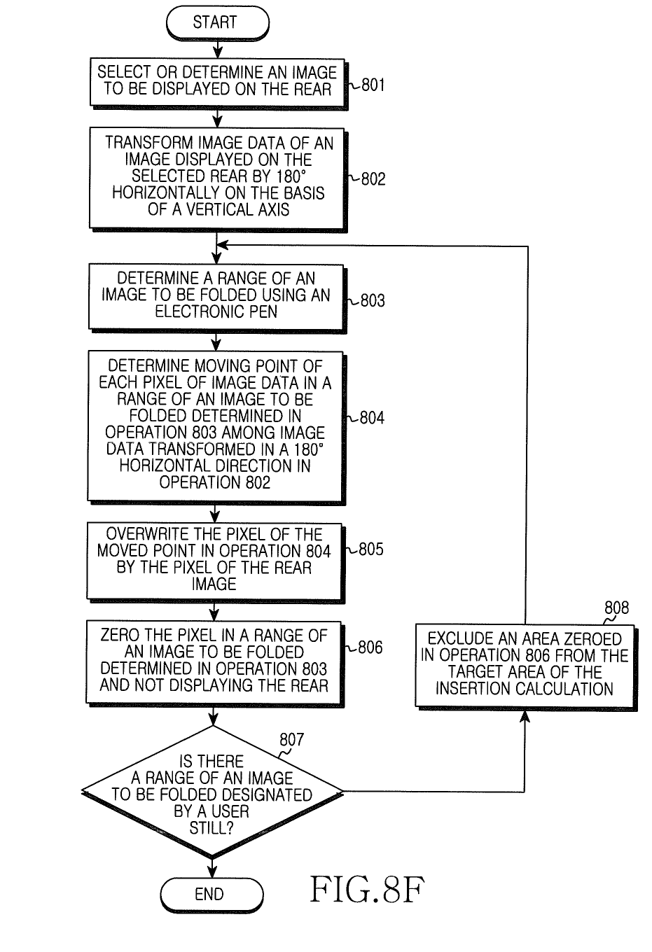

FIG. 8A to FIG. 8D are views of displaying an image of the rear of a memo frame when the memo frame is transformed in an electronic device according to an embodiment of the present disclosure. Referring to FIG. 8A to FIG. 8D, the electronic device can confirm a transformation point and transformation method of a memo frame by detecting a user's gesture.

The electronic device can define a point where a user's gesture is detected as a transformation point. That is, the form of a memo frame can be transformed on the basis of the gesture detected point.

For example, when detecting a user's gesture 801 moving from the bottom to the top as shown in FIG. 8(A), the electronic device can process 803 the front sides of the memo frame to overlap each other. Here, the front side of the memo frame is a side where a written memo is displayed and the front sides of two portions overlap each other on the basis of a transformation point. In FIG. 8A, a user's gesture occurs at the left top corner of the memo frame. Furthermore, the user's gesture moves from the left side to the top side and occurs in the direction of 1:00.

As another example, when detecting a user's gesture 811 moving from the top to the bottom as shown in FIG. 8(B), the electronic device can process 813 the back sides of the memo frame to overlap each other. Here, the back side of the memo frame is a side where a written memo is not displayed and the back sides of two portions overlap each other on the basis of a transformation point. In FIG. 8B, a user's gesture occurs at the left top corner of the memo frame. Furthermore, the user's gesture moves from the top side to the left side and occurs in the direction of 7:00.

The electronic device can confirm the transformation method of the memo frame by using a gesture occurrence direction. The electronic device can confirm the transformation method for the memo frame by detecting a gesture determining such a method and a transformation method.

That is, after detecting a user's gesture and defining a transformation point 821 as shown in FIG. 8C), the electronic device can confirm a side to be transformed and a transformation method by detecting a user's gesture.

That is, when a user's gesture is detected from a memo frame, a transformation point corresponding to a dotted line can be determined and the memo frame can be divided into two sides on the basis of the transformation point.

Then, the electronic device can confirm a side to be transformed among divided sides and confirm a transformation method for the confirmed side.

As shown in FIG. 8C, after a user selects one side from the divided sides and a gesture 825 corresponding to the first direction is detected, the electronic device can transform 827 the memo frame according to a first transformation method.

As shown in FIG. 8C, the gesture corresponding to the first direction can be a gesture selecting a side to be transformed and moving it to the inside. Furthermore, the first transformation method can be a method for folding the side selected by a user toward the front side of the memo frame. Accordingly, the front sides of the memo frame can be transformed to overlap each other on the basis of the transformation point.

Furthermore, as shown in FIG. 8D, after a user selects one side from the divided sides and a gesture 831 corresponding to the second direction is detected, the electronic device can transform 833 the memo frame according to a second transformation method.

As shown in FIG. 8D, the gesture corresponding to the second direction can be a gesture selecting a side to be transformed and moving it to the outside. Furthermore, the second transformation method can be a method for folding the side selected by a user toward the back side of the memo frame. Accordingly, the back sides of the memo frame can be transformed to overlap each other on the basis of the transformation point.

Additionally, although a user's gesture is inputted using an electronic pen as shown in FIG. 8A to FIG. 8D, a corresponding gesture can be inputted by a finger's contact, voice recognition, or a text input.

Furthermore, as another embodiment of FIG. 8E, in relation to a transformation method of folding the front of a memo frame as shown in FIG. 8C, an image can be prepared on the rear of the memo frame in advance and the image of the rear of the memo frame can be displayed when folded. This is shown in detail in FIG. 8E and FIG. 8F.

FIG. 8E is a view of displaying an image of the rear in a transformation method of folding the front of the memo frame as shown in FIG. 8F. A user's gesture for designating a transformation point as shown in the memo frame at the left 835 of FIG. 8E is inputted through an electronic pen. Then, as shown in the memo frame at the right 836 of FIG. 8E, an image prepared on the rear in advance can be displayed. Its detailed method is described below.

FIG. 8F is a flowchart illustrating a detailed display method in a modified embodiment of a rear image display of FIG. 8E. In operation 801, an image to be displayed on the rear can be selected or determined.

In operation 802, image data of an image displayed on the selected rear can be transformed (rotated) by 180° horizontally on the basis of a vertical axis 837 at the left 835 of FIG. 8E. The reason for this is that an image at the rear is rotated by 180° horizontally as seen from the front.

In operation 803, a range of an image to be folded using an electronic pen can be determined. According to various embodiments of the present disclosure, a folding wrinkle (that is, a transformation point) for defining a range of an image to be folded can be a straight line as shown in FIG. 8E. According to various embodiments of the present disclosure, a corresponding folding wrinkle can be defined as the Equation (1) below by defining a horizontal axis as a y axis and a vertical axis as an x axis on the basis of the center of a memo frame as an origin.

ax+by+c=0 (Equation 1)

In operation 804, each pixel (moving point of each pixel) of image data in a range of an image to be folded determined in operation 803 among image data of an image displayed at the rear transformed in a 180° horizontal direction can be determined.

In relation to this detailed method, when a position B(p, q) where a position A(r, s) of an image (i.e., an image displayed at the rear) at a range rear of an image to be folded (moved) uses affine transformation, this can be defined as Equations below.

p={(b2−a2)r−2abs−2ac]/(a2+b2) (Equation 2)

q={−(b2−a2)s−2abr−2bc]/(a2+b2) (Equation 3)

In operation 805, the pixel of the moved point B(p, q) in operation 804 can be overwritten by the pixel of the rear image at the position of the point A(r, s).

In operation 806, insertion can be terminated by zeroing the pixel in a range of an image to be folded determined in operation 803 and not displaying the rear.

Additionally, if there is a range of an image to be folded designated by a user still in operation 807, after excluding an area zeroed in operation 806 from the target area of the insertion calculation in operation 808, operations 803 to 806 can be repeated.

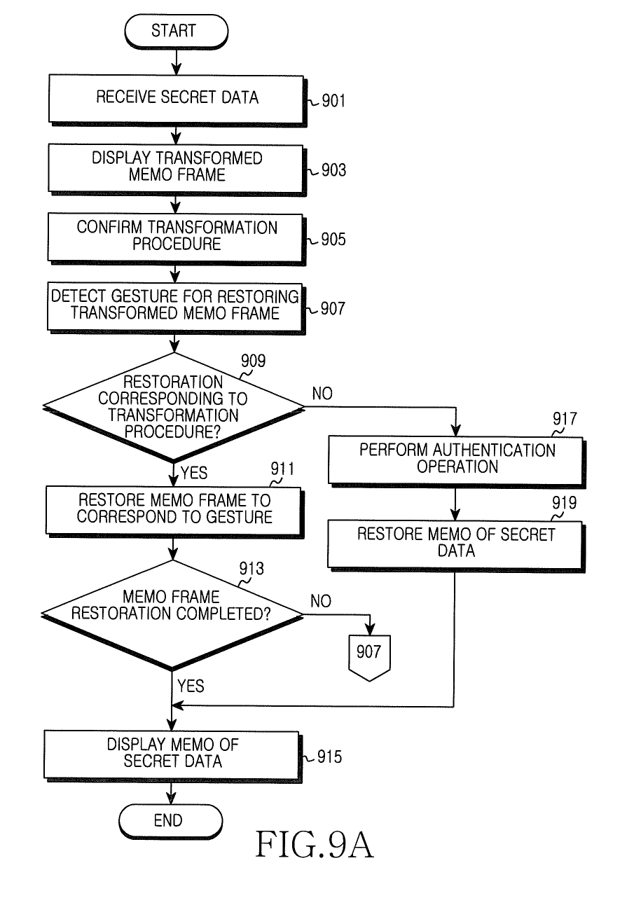

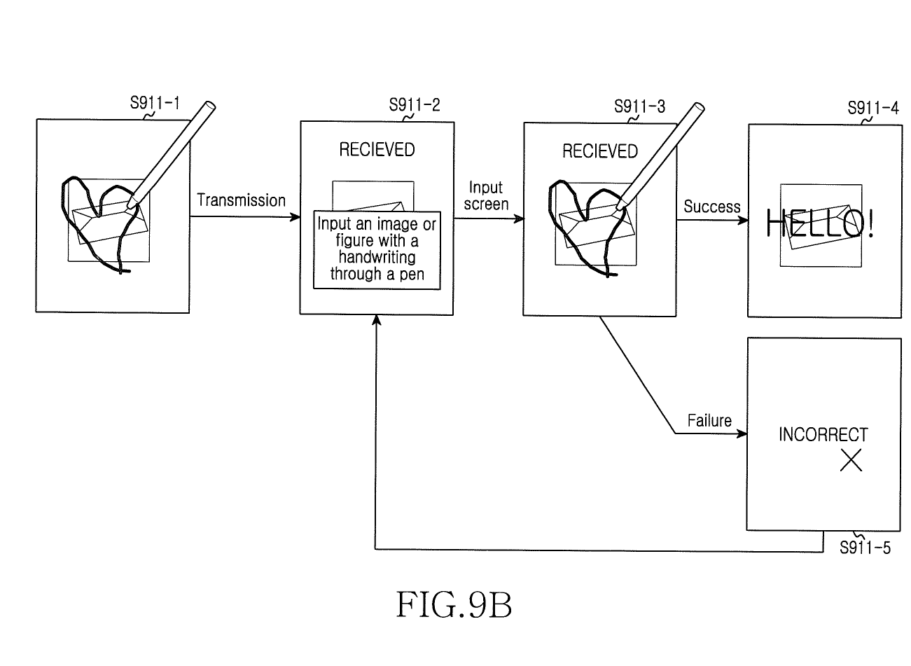

Moreover, an image at the rear of the memo frame can be displayed by adding an operation of flipping the memo frame during an operation of unfolding the folded area by a receiver (shown in FIG. 9A).

Information such as an image can be added to the rear of the folded area through the above operations and a user can image information at the rear from the image after partially folding the memo frame in a folded state or can send a similar memo to an actually decorated letter. Furthermore, when the folded area is completed unfolded, image information at the rear can be confirmed.

FIG. 9A is a flowchart illustrating an operation of playing secret data in an electronic device according to an embodiment of the present disclosure.

Referring to FIG. 9A, the electronic device can tag a transformation procedure while secret data are generated.

That is, when the secret data of the transformed memo frame are restored in the reverse order, the electronic device can decrypt the secret data.

Moreover, the electronic device can confirm whether secret data of the transformed memo frame are generated while transforming the form of the memo frame in operation 411.

Furthermore, the electronic device can transform the form of the memo frame before the secret data are generated.

Moreover, when the form of the memo frame is transformed and secret data are generated, the electronic device can tag a transformation procedure of the memo frame to the secret data and store it.

Here, the tagging of the transformation procedure is to add a transformation order of the memo frame to the secret data. This is because the transformation order of a memo frame can be used as decryption information on the secret data. Of course, the electronic device can separate the secret data from the transformation procedure and store them.

That is, when the memo frame is restored in the reverse order of the transformation order, the electronic device receiving the secret data can display a memo displayed in the memo frame on a display unit.

The electronic device for playing secret data can perform the following operation.

The electronic device can receive secret data from a peripheral electronic device in operation 901.

At this point, the electronic device can receive secret data including a tagged transformation procedure. Of course, the electronic device can play the secret data generated and stored by the electronic device.

Moreover, the electronic device can display the transformed memo frame, that is, the secret data generated by transforming the form of the memo frame, in operation 903.

At this point, the electronic device can display the memo frame whose form is transformed to generate the secret data.

Furthermore, the electronic device can confirm a transformation procedure tagged to the received secret data in order to play the secret data in operation 905.

Of course, the electronic device can separate the secret data from the transformation procedure and receive them.

In addition, the electronic device can detect a gesture for restoring the transformed memo frame in operation 907.

Here, a gesture for restoring the transformed memo frame can be a gesture corresponding to the reverse order of transforming the memo frame while secret data are generated.

In addition, the electronic device can confirm whether the restoration of the memo frame corresponds to the transformation procedure and then can perform an operation according to a confirmation result in operation 909.

That is, if the restoration of the memo frame does not correspond to the transformation procedure, the electronic device can perform an authentication operation in operation 917. At this point, if restoration that does not correspond to the predetermined number of transformation procedures is detected, the electronic device can perform an authentication operation.

Furthermore, if the authentication operation is successful, the electronic device can display a memo by restoring the memo frame included in the secret data in operation 919. That is, although a user does not generate a gesture corresponding to memo restoration, the electronic device determines a user as someone authorized for secret data through an authentication operation and thus restores the memo frame.

Furthermore, if the restoration of the memo frame corresponds to the transformation procedure, the electronic device can restore the memo frame corresponding to the gesture in operation 911. At this point, the electronic device can display the restored memo frame. Additionally, as described below with reference to FIG. 9B, at this point, a function of determining whether a receiver has an authority to open the memo frame can be added.

In addition, the electronic device can confirm whether the memo frame is restored by a user in operation 913.

Furthermore, the electronic device can confirm whether the memo frame is restored normally by detecting a user's gesture before the restoration of the memo frame is completed.

Furthermore, if the restoration of the memo frame is completed, the electronic device can display a memo included in the memo frame in operation 915.

FIG. 9B is a view illustrating an opening determining function when a memo frame is restored by an electronic device. In more detail, each order of FIG. 9B is to authenticate a proper receiver before restoring the memo frame according to a predetermined transformation order in FIG. 9A and corresponds to the case that an authentication function is added to allow only a receiver who transforms a memo to open the memo.

A transmitter can designate a handwriting necessary for allowing a receiver to open a message after transforming the memo frame (operation 407 of FIG. 4) through procedures described with FIGS. 6 to 8. For example, as shown in operation 911-1, a transmitter can draw a heart mark with own handwriting and an image interpretation unit (not shown) of an electronic device can interpret a corresponding handwriting, preserve handwriting data as digital data, and transmit the handwriting data stored together with a corresponding memo frame to a receiver.

The receiver receives the transformed memo frame and tries to open the memo frame through a predetermined procedure (operations 901 to 907 of FIG. 9A). Then, as shown in 911-2, it can prompt to input an image or figure with a transmitter's handwriting through a pen (this is just one example, it can be a finger's contact, voice recognition, or a text input). In this embodiment, the receiver needs to draw a heart mark with the transmitter's handwriting. Additionally, the receiver can receive a message that the receiver needs to draw a heart mark with the transmitter's handwriting, from the transmitter through any kinds of means.

Then, a handwriting identity determination unit (not shown) in an electronic device of the receiver compares the handwriting data inputted by the receiver with the handwriting data by the transmitter of the received memo and determines whether the handwriting data are identical to each other in operation 911-3. If it is determined that whether the handwriting data are identical to each other, the electronic device determines that an open instruction is provided from the proper receiver and then opens the memo through a predetermined memo frame transformation order (911-4) (after operation 905 of FIG. 9A). If they are not identical to each other, the electronic device determines that an open instruction is not provided from the proper receiver and then displays an opening failure notification in operation 911-5.

Additionally, although the opening determination by the handwriting during the restoration of the memo frame is described, in the case of opening the memo by a voice, a voice identity determination unit is prepared, so that voice identity can be determined through the same order as that in the handwriting determination. Additionally, when opening determination is made through a touch operation such as touching a cross on the memo frame with a finger, a touch operation identify determination unit is prepared, so that the identity of a touch operation can be determined through the same order as that in the handwriting identity determination.

In such a way, by using handwriting, voice, or a touch operation in addition to the memo frame transforming method, a memo is not likely to be exposed to the others except for a transmitter's indented receiver.

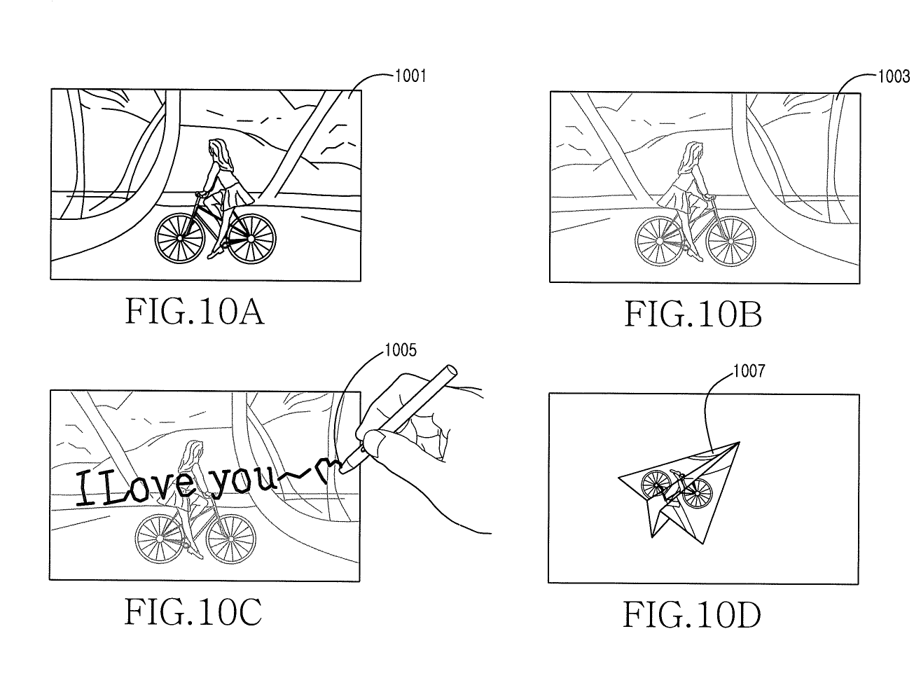

FIGS. 10A to 10D illustrate an operation of generating secret data in an electronic device according to an embodiment of the present disclosure.

The electronic device can write a memo by executing a memo input available application such as a memo application, a document application, an image edit application, a text message writing application, and an e-mail writing application.

In addition, the electronic device can write a memo on image data as shown in FIG. 10C. That is, when an event for writing a memo on image data occurs as shown in FIG. 10A, the electronic device can display a memo writing available area on the displayed image data 1001. For example, when a memo writing event occurs, the electronic device can display 1003 the back side of image data as shown in FIG. 10B and can write a memo on the back side of image data.

Of course, the electronic device can display an additional layer on the front side of the image data and can write a memo thereon. In this case, the memo can be included in the image data.

As mentioned above, after a memo is written on a memo writing available area, the electronic device can transform the form of the written image data.

That is, after a memo is written 1005 on the back side of the image data as shown in FIG. 10C, the image data including the written memo can be transformed into data in a form corresponding to a user's request as shown in FIG. 10D.

FIGS. 10A to 10D illustrate that image data including a written memo are transformed into data in a paper airplane form in response to a user's request. When the form of image data including a written memo is transformed as described above, the contents of the image data and the written memo may not be exposed to others.

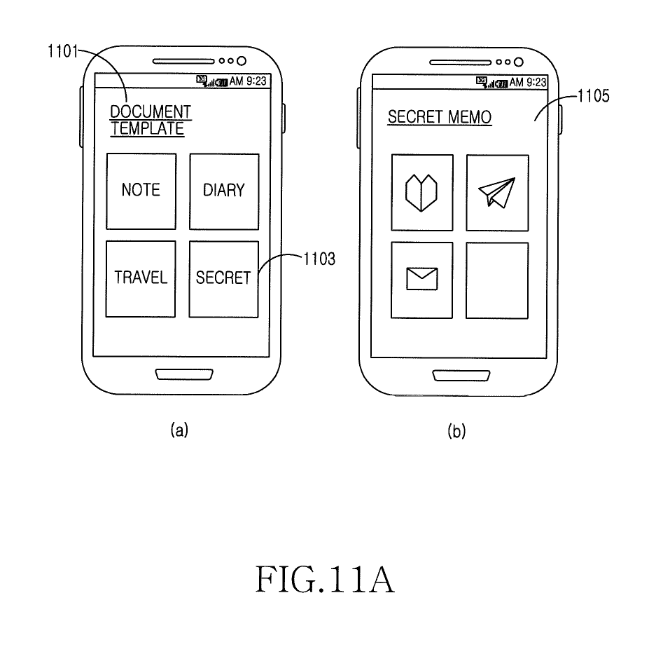

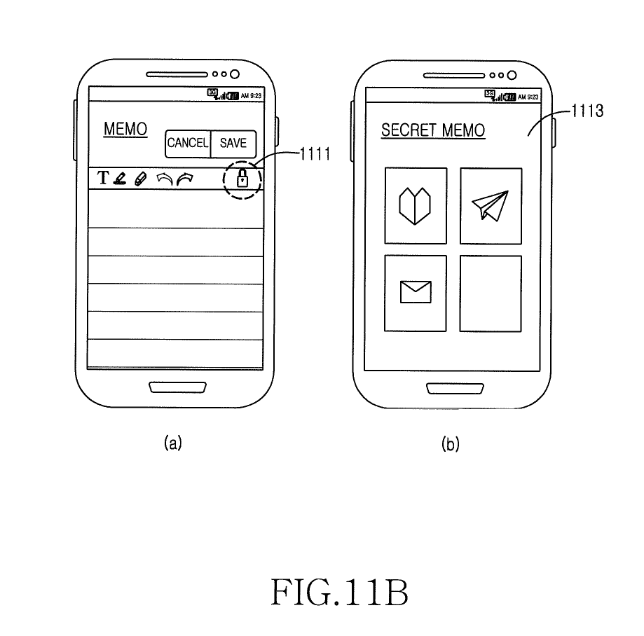

FIG. 11A and FIG. 11B are views illustrating an operation of generating secret data in an electronic device according to an embodiment of the present disclosure.

The electronic device can write a memo by executing a memo input available application such as a memo application, a document application, an image edit application, a text message writing application, and an e-mail writing application.

In such a case, the electronic device can provide a list for a memo frame. That is, the electronic device can provide a document template corresponding to a situation as shown in FIG. 11A, thereby allowing a user to write a memo corresponding to a corresponding template.

For example, as shown in FIG. 11A, the electronic device can provide 1101 a memo frame corresponding to a note, a memo frame corresponding to a diary, and a memo frame corresponding to a travel journal. The above memo frame is a frame optimized for characteristics of each memo frame. For example, the memo frame for a travel journal can be a memo frame including an area where a travel photo is added and an area where a memo for an added photo is written.

The electronic device can add a memo frame 1103 for writing secret data.

When a user's selection is detected in the case of writing the secret data, the electronic device can provide 1105 a template list displaying forms of transformed secret data as shown in FIG. 11A. The electronic device can confirm that secret data are generated before a memo is written, as shown in FIG. 11A.

Furthermore, the electronic device can confirm that secret data are generated when a written memo is stored, as shown in FIG. 11B. That is, as shown in FIG. 11B, the electronic device can display a menu 1111 for storing data as secret data on a memo writing screen.

According to various embodiment of the present disclosure, a lock icon can be a menu for generating data as secret data.

Once a selection on such a menu is detected, the electronic device can provide a template list 1113 displaying forms of transformed secret data as shown in FIG. 11B.

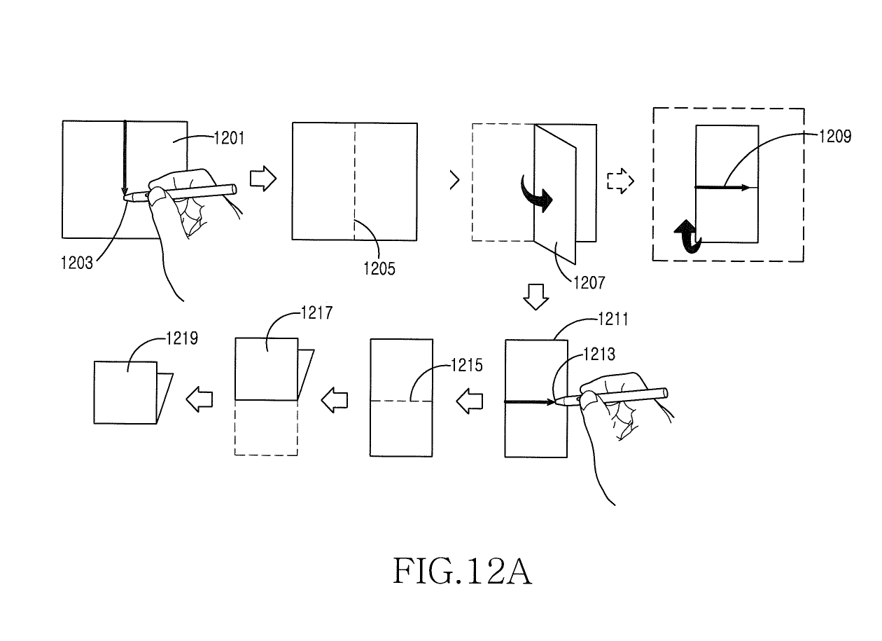

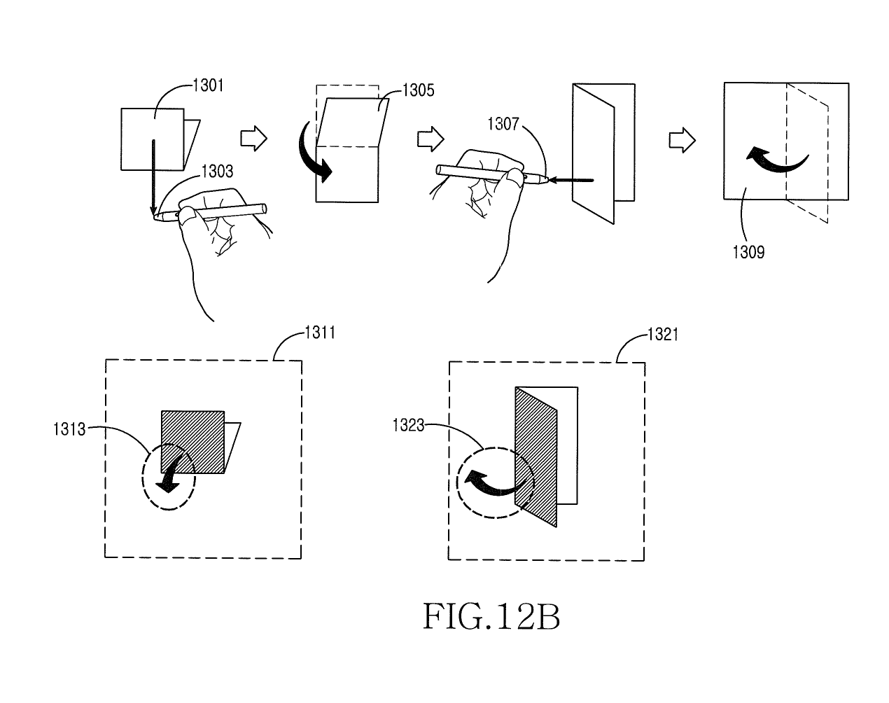

FIG. 12A and FIG. 12B are views illustrating an operation of providing a guideline for secret data in an electronic device according to an embodiment of the present disclosure.

The electronic device can transform the form of a memo frame by using a user's gesture. At this point, the electronic device can store a procedure for transforming the form of a memo frame in advance.

When detecting a user's gesture 1203 for a memo frame 1201 as shown in FIG. 12A, the electronic device can confirm a transformation point 1205 for the memo frame 1201 and then can transform the form on the basis of the transformation point 1205. That is, as shown in FIG. 12A, the electronic device can fold a rectangular memo frame by half by detecting a user's gesture, thereby transforming the form.

Furthermore, after transforming the form of the memo frame, the electronic device can confirm a transformation point 1215 by detecting a user's gesture 1213 that is additionally detected on the transformed memo frame 1211 and can transform 1217 the form of the memo frame on the basis of the transformation point of the transformed memo frame.

As shown in FIG. 12A, it is confirmed that the rectangular memo frame 1201 is transformed into a ¼ size form.

The electronic device can provide a guideline for a situation transformable from a current form while the form of a memo frame is transformed. That is, as shown in a situation 1201 indicated by a dotted line, the electronic device can notify a user a situation 1209 where the memo frame can be folded by half.

A user, who does not recognize the transformation method of the memo frame, can transform the form of the memo frame by referring to the displayed guideline.

Furthermore, the electronic device can display a written memo by restoring the secret data as shown in FIG. 12B. That is, the electronic device can restore the form of the memo frame by using a user's gesture 1303 detected on the transformed memo frame 1301.

As shown in FIG. 12B, the electronic device detecting a user's gesture for unfolding the secret data transformed into a ¼ size transforms 1305 the memo frame.

Furthermore, the electronic device detecting a user's gesture 1307 for completely unfolding the memo frame transformed to a ½ size restores 1309 the memo frame normally.

Furthermore, the electronic device can provide a guideline for a situation restorable from a current form while the form of a memo frame is restored. That is, as shown in situations 1311 and 1321 indicated by a dotted line, the electronic device can notify a user a situation 1313 where a memo frame of a ¼ size is unfolded to a ½ size and a situation 1323 where a memo frame of a ½ size is unfolded to a normal size.

A user, who does not recognize the transformation method of the memo frame, can restore the transformed memo frame by referring to the displayed guideline.

According to various embodiments of the present disclosure, an operation of an electronic device can include an operation of inputting a memo to a memo frame by detecting a user's gesture and an operation of transforming the form of the memo frame by detecting a user's gesture.

According to various embodiments, an operation of the electronic device can include an operation of tagging a transformation procedure by the gesture to the transformed memo frame and an operation of storing the memo frame including the tagged transformation procedure.

According to various embodiments, an operation of transforming the form of the memo frame by detecting the user's gesture can include an operation of displaying a list of transformable forms.

According to various embodiments, an operation of transforming the form of the memo frame by detecting the user's gesture can include an operation of confirming the transformation method of the memo frame according to the detected gesture and an operation of transforming the form of the memo frame according to the confirmed transformation method.

According to various embodiments, an operation of transforming the form of the memo frame by detecting the user's gesture can include an operation of confirming the transformation point of the memo frame according to the detected gesture and an operation of transforming the form of the memo frame on the basis of the confirmed transformation point.

According to various embodiments, an operation of the electronic device can include an operation of transmitting the memo data including the tagged transformation procedure.

According to various embodiments, on the receipt of the memo tagged with the transformation procedure, an operation of the electronic device can include an operation of restoring the transformed memo frame by detecting a gesture corresponding to the transformation procedure.

According to various embodiments, the method can further include an operation of storing a transmitter's opening determination gesture of a memo tagged with a transformation order of the memo frame.

According to various embodiments, a receiver of data tagged with the transformation procedure can reproduce the opening determination gesture and when the stored opening determination gesture is identical to the reproduced opening determination gesture, the method can include an operation of restoring the transformed data.

According to various embodiments, the restoration of the transformed data can detect a gesture corresponding to the transformation order and can include restoring the transformed data.

According to various embodiments, the gesture can include at least one of handwriting, voice, and a touch operation

According to various embodiments, on the receipt of the memo tagged with the transformation procedure, an operation of restoring the transformed memo frame by detecting a gesture corresponding to the transformation procedure can include an operation of performing an authentication operation for memo confirmation if the gesture corresponding to the transformation procedure is not detected.

According to various embodiments, the method can include an operation of confirming that a transformation point of a memo frame is confirmed according to a detected gesture and transforming data on the basis of the confirmed transformation point. According to various embodiments, the operation can include an operation of folding the memo frame.

According to various embodiments, when the memo frame is folded, the method can include an operation of displaying an image installed at the front of the memo frame.

According to various embodiments, at least part of a device (for example, modules or functions thereof) or a method (for example, operations) can be implemented using instructions stored in computer-readable storage media as in the form of a programming module. When the instructions are executed by at least one processor (for example, the processor 122), the at least one processor can perform a function corresponding to the instructions. The computer-readable storage media can include the memory 110, for example. At least part of the programming module can be implemented (for example, executed) by the processor 122, for example. At least part of the programming module can include a module, a program, a routine, sets of instructions, or a process to perform at least one function, for example.

The computer-readable storage media can include specially configured hardware devices storing and executing program instructions (for example, a program module), for example, magnetic media such as hard disk, floppy disk, and magnetic tape, optical media such as Compact Disc Read Only Memory (CD-ROM) and Digital Versatile Disc (DVD), Read Only Memory (ROM), Random Access Memory (RAM), and flash memory. Additionally, a program instruction can include machine language codes created by a compiler and also high-level language codes executed by a computer through an interpreter. The hardware device can be configured to operate as at least one software module for performing an operation and vice versa.

Additionally, a module or a programming module according to an embodiment of the present disclosure can be configured including at least one of the above-mentioned components or additional other components. Operations performed by a module, a programming module, or another component according to an embodiment of the present disclosure can be performed through a sequential, parallel, repetitive, or heuristic method. Moreover, some operations may be performed in another order or omitted and other operations may be added.

According to various embodiments, in relation to storage media storing instructions, when being executed by at least one processor, the instructions are set to perform at least one operation by using the at least one processor. The at least one operation may include an operation of inputting a memo to a memo frame by detecting a user's gesture and an operation of transforming the form of the memo frame by detecting a user's gesture.

The electronic device transforms the form of a memo frame including a written memo and an electronic device receiving the data restores the form of the memo frame according to a transformation procedure, so that security on memo data may be improved.

While the disclosure has been shown and described with reference to certain preferred embodiments thereof, it will be understood by those skilled in the art that various changes in form and details may be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. An electronic device for storing data in an electronic device, the device comprising:
at least one processor;
a memory; and
at least one program stored in the memory and executed by the at least one processor,
wherein the program causes the at least one processor to:
receive data from a user
detect a user's gesture; and
transform a form of the data based on the detected user's gesture.

2. The device of claim 1, wherein the program causes the at least one processor to tag a transformation procedure by the gesture on the transformed data and store the data tagged with the transformation procedure.

3. The device of claim 1, wherein the program comprises an instruction to display a list of transformable forms.

4. The device of claim 1, wherein the program causes the at least one processor to confirm a transformation point of data according to a detected gesture and transform the data on the basis of the confirmed transformation point.

5. The device of claim 1, wherein the program comprises an instruction to confirm a transformation method of data according to the detected gesture and transforming the data through the confirmed transformation method.

6. The device of claim 1, wherein the program comprises an instruction to transmit the data tagged with the transformation procedure of the data form.

7. The device of claim 1, wherein the program comprises an instruction to restore transformed data by detecting a gesture corresponding to the transformation procedure when receiving the data tagged with the transformation procedure of the data form.

8. The device of claim 1, wherein the program comprises an instruction for storing a transmitter's opening determination gesture the data tagged with the transformation procedure of the data form.

9. The device of claim 8, wherein a receiver of the data tagged with the transformation procedure reproduces the opening determination gesture and when the stored opening determination gesture is identical to the reproduced opening determination gesture, restores the transformed data.

10. The device of claim 9, wherein the restoration of the transformed data comprises detecting a gesture corresponding to the transformation order and restoring the transformed data.

11. The device of claim 8, wherein the opening determination gesture comprises at least one of handwriting, voice, and a touch operation.

12. The device of claim 7, wherein the program comprises an instruction to perform an authentication operation to confirm whether to access data if the gesture corresponding to the transformation procedure is not detected.

13. The device of claim 1, wherein the program comprises an instruction for confirming a transformation point of a memo frame according to a detected gesture and transforming data on the basis of the confirmed transformation point, wherein the instruction comprises an instruction for folding the memo frame forwardly.

14. The device of claim 13, wherein the program comprises an instruction for displaying an image prepared at the rear of the memo frame when the memo frame is folded forwardly.

15. A method in an electronic device, the method comprising:
receiving a memo from a user;
framing a memo with a memo frame;
detecting a user's gesture; and
transforming a form of the memo frame based on the detected user's gesture.

16. The method of claim 15, further comprising:
tagging a transformation procedure by the gesture on the transformed memo frame; and
storing the memo frame tagged with the transformation procedure.

17. The method of claim 15, wherein transforming the form of the memo frame by detecting the user's gesture comprises displaying a list of transformable forms.

18. The method of claim 15, wherein transforming the form of the memo frame by detecting the user's gesture comprises:
confirming a transformation method of a memo frame according to a detected gesture; and
transforming a form of the memo frame through the confirmed transformation method.

19. The method of claim 15, wherein transforming the form of the memo frame by detecting the user's gesture comprises:
confirming a transformation point of a memo frame according to a detected gesture; and
transforming a form of the memo frame on the basis of the confirmed transformation point.

20. The method of claim 15, further comprising:
transmitting the memo data tagged with the transformation procedure of the memo frame form.

21. The method of claim 15, wherein storing the memo data in the electronic device comprises restoring the transformed memo frame by detecting a gesture corresponding to the transformation procedure when the memo tagged with the transformation procedure of the memo frame form is received.

22. The method of claim 16, further comprising an operation of storing the transformation procedure of the memo frame and a transmitter's opening determination gesture.

23. The method of claim 22, wherein a receiver of the data tagged with the transformation procedure reproduces the opening determination gesture and when the stored opening determination gesture is identical to the reproduced opening determination gesture, further comprising an operation of restoring the transformed data.

24. The method of claim 23, wherein the restoring of the transformed data comprises detecting a gesture corresponding to a transformation order and restoring the transformed data.

25. The method of claim 22, wherein the gesture comprises at least one of handwriting, voice, and a touch operation.

26. The method of claim 21, wherein restoring the transformed memo frame by detecting the gesture corresponding to the transformation procedure when the memo tagged with the transformation procedure is received comprises performing an authentication operation for memo confirmation when the gesture corresponding to the transformation procedure is not detected.

27. The method of claim 15, further comprising an operation of confirming a transformation of a memo frame according to a detected gesture and transforming data on the basis of the confirmed transformation point, wherein the operation comprises an operation of folding the memo frame forwardly.

28. The method of claim 27, further comprising when the memo frame is folded forwardly, an operation of displaying an image prepared at the rear of the memo frame.

29. A computer readable storage medium storing a program for use with a processing circuitry, the program causing the processing circuitry to:
receive data from a user;
frame the data with a memo frame;
detect a user's gesture; and
transform a form of the memo frame according to the a user's gesture.

30. The computer readable storage medium of claim 29, the program further causing the processing circuitry to:
tag a transformation procedure by the gesture on the transformed memo frame; and
store the memo frame tagged with the transformation procedure.

31. The computer readable storage medium of claim 17, wherein the program causes the processing circuitry to display a list of transformable forms.

32. The computer readable storage medium of claim 17, wherein the program causes the processing circuitry to:
confirm a transformation method of a memo frame according to a detected gesture; and
transform a form of the memo frame through the confirmed transformation method.
